(19) United States
(12) Patent Application Publication
(10) Pub. No.: US 2005/0022192 A1
(43) Pub. Date: Jan. 27, 2005

(54) Apparatus and method for simultaneous multi-thread processing

(76) Inventor: Min-Su Kim, Hwasung-gun (KR)

Correspondence Address: HARNESS, DICKEY & PIERCE, P.L.C., P.O. BOX 8910, RESTON, VA, 20195, US

(21) Appl. No.: 10/840,374

(22) Filed: May 7, 2004

(30) Foreign Application Priority Data
Jul. 22, 2003 (KR) 2003-50123

(51) Int. Cl. G06F 9/46

(52) U.S. Cl. 718/100

(57) ABSTRACT

A method and apparatus for data processing including a microprocessor for simultaneously processing a plurality of processes, where a process memory is assigned to one or more processes, the processes include corresponding threads of that are assigned to corresponding thread memories that are independent from the process memory, and have access to the process memory.

### BACKGROUND OF THE INVENTION

This application claims the priority of Korean Patent Application No. 2003-50123, filed on Jul. 22, 2003 in the Korean Intellectual Property Office, the disclosure of which is incorporated herein in its entirety by reference.

1. Field of the Invention

The present invention relates to a method and apparatus of a microprocessor that performs a process containing one or more threads, the process operates in a process memory and the threads operate in separate thread memories.

2. Description of Related Art

A microprocessor may be designed to perform arithmetic and/or logic operations using a micro-sized memory device and/or a register. The operations of the microprocessor may include addition, subtraction, comparison of two numbers, and/or a number shift. These operations may be the result of a command set operation, which is part of the microprocessor design. When driving a computer, a microprocessor may be designed to automatically execute a first command of a basic input/output system (BIOS). The microprocessor may operate from commands that the BIOS, an operating system (OS) and/or application programs execute.

With advances in semiconductor process technology, the number of transistors constructed in a unit area may be increased, thus construction of circuits on microprocessor chips may become more complex.

As the amount of data processed in a microprocessor increases, data processing speed may become a performance factor of the microprocessor. In the past, various efforts have been made for enhancing the processing speed of a microprocessor. Some examples of these efforts include a multi-stage pipeline, a super scaler, a virtual memory address, and an internal cache. In recent years, simultaneous-multi-thread (SMT) technology has been used to enhance the processing speed of a microprocessor. SMT technology may contain two or more programs, i.e., two or more processes, which may be performed in a central processing unit (CPU) without performance degradation.

Some microprocessors have a virtual memory space and/or a virtual memory address for more efficient use of memory. In a microprocessor supporting virtual memory, the virtual memory address may be different from a physical memory address. For example, the virtual memory address may be an address area viewed by programmers, and the physical memory address may be a memory address space used for accessing an actual memory.

In a conventional microprocessor, one process may have one virtual memory space, for example, for a 32-bit microprocessor, one process may have one virtual memory space of, for example, 4 GB. This virtual memory space may be mapped to a physical memory space by using an address mapping table for translating a virtual memory address into a physical memory address. The virtual page number may be translated into a physical page number using the address mapping table for accessing a practical memory. The address mapping table may be referred to as a translation lookaside buffer (TLB). Such a translation may be applied to a non-SMT microprocessor or an SMT-realized microprocessor.

FIG. 1A and FIG. 1B illustrate a virtual memory address translated into a physical memory address by a conventional TLB. FIG. 1A illustrates an address translation when a process ID is included. The process ID may be expressed as an address space number (ASN).

In FIG. 1A, a virtual memory address includes a process ID, a virtual page number, and a page offset. In FIG. 1B, a virtual memory address may include a virtual page number and a page offset.

To increase the efficiency for translating a virtual memory address into a physical memory address, the translation may be performed with a page unit of 4 Kbytes. In this case, the entire virtual memory address is not translated into the entire physical memory address, but only upper virtual page numbers (including a process ID) may be translated into physical page numbers. The virtual page and the physical page may pass in their entirety without translation.

FIG. 2A and FIG. 2B illustrate a configuration of a conventional TLB. FIG. 2A illustrates the case when a process ID is included and FIG. 2B illustrates the case when a process ID is not included. The conventional TLB may also contain a separate tag and data portion.

In FIG. 2A, the tag of the TLB may include a process ID, a virtual page number, and a page offset, including a valid (V) and lock (L) parameter, and the data portion may include a physical page number and protection such as access permission.

The operation of the above-described TLB includes an inputted process ID and a virtual page number, which may be compared with tag content stored in the TLB. If they match and the V has a valid value, a physical page number of a corresponding entry and protection information may be outputted.

SMT processing includes a plurality of processes or threads simultaneously performed in one CPU. A process may include a plurality of threads. In the case of a microprocessor in which SMT is realized, a plurality of processes can be simultaneously performed in one CPU using a memory management unit (MMU) or a TLB. Unfortunately, problems may arise when one process having a plurality of threads is performed in an SMT environment.

When a program is executed in a microprocessor, there may be a parent process and a plurality of child processes in the parent process, which may result in memory sharing problems. The child process may be independent of the parent process and may have an independent memory space. If communication is required between the parent process and the child process, it may only be accomplished through a hard disk file or a kernel of an operating system (OS). Therefore, it may not be possible to directly access reciprocal memory areas.

When a single program is executed in a microprocessor, a program may be executed with a structure for one process and a plurality of threads in the process. In this case, all the threads in the process can share memory and resources. In the case where communication between threads is needed, it is possible to access an opponent memory. Thus, data can be more efficiently processed at a higher speed. However, memory sharing problems may arise when the threads share memory.

### SUMMARY OF THE INVENTION

Exemplary embodiments of the present invention provide a method and apparatus which perform processing on a plurality of processes operating within a microprocessor, the processes contain threads having separate memory spaces which may reduce memory collision and other memory sharing problems that may arise.

An exemplary embodiment of the present invention provides a microprocessor for simultaneously processing a plurality of processes including assigning at least one process memory to a plurality of processes, and assigning a plurality of thread memories to a plurality of threads in the corresponding plurality of processes, where the plurality of thread memories are independent from the process memory.

Exemplary embodiments of the present invention provide each of the plurality of thread memories being assigned to a corresponding thread.

Exemplary embodiments of the present invention further provide the process memory being used by the plurality of threads.

Another exemplary embodiment of the present invention provides a translation lookaside buffer of a microprocessor including, a tag unit which includes a thread ID, and a virtual memory page number, and also includes a data unit which includes a physical memory page number. The data unit corresponds to the tag unit and is used to translate a virtual memory address into a physical memory address.

Exemplary embodiments of the present invention provide a translation lookaside buffer where the tag unit includes a process ID, and a thread bit for determining whether the virtual memory address is an address for a process memory or a thread memory.

An exemplary embodiment of the present invention provides an apparatus including a process memory corresponding to a process having at least one thread, a thread memory corresponding to the at least one thread and independent from the process memory, where the process and the at least one thread have access to the process memory.

Another exemplary embodiment of the present invention provides a virtual memory containing at least one process memory and at least two thread memories, where each of the at least two thread memories correspond to individual threads that are independent from the at least one process memory.

Exemplary embodiments of the present invention provide thread memories, which do not have access to other thread memories and only have access to the at least one process memory, where the thread memories may only be accessed by the at least one process memory, where the thread memories being accessed by the at least one process memory includes performing a read operation, and the at least one process memory is used by one of the at least two threads to access another one of the at least two threads, and where the at least one process memory is the only memory that may be used by one of the at least two threads to access another one of the plurality of threads.

An exemplary embodiment of the present invention provides a method of assigning a virtual memory to a microprocessor including assigning at least one process to a process memory, and assigning at least one thread in the process to a thread memory, where the thread memory is independent from the process memory.

Another exemplary embodiment of the present invention provides a method of translating a virtual memory address into a physical memory address by determining the value of a thread bit, and performing an operation in a thread memory or process memory depending upon the determined thread bit value.

Exemplary embodiments of the present invention provide the determined thread bit value to cause the performed operation to be a thread operation, and the thread operation is performed in a corresponding thread memory.

Exemplary embodiments of the present invention provide the determined thread bit value to cause the operation performed to use the process memory to transmit at least one of data, a message and a parameter.

### BRIEF DESCRIPTION OF THE DRAWINGS

The above and other examples and exemplary embodiments of the present invention will become more apparent by describing in detail exemplary embodiments thereof with reference to the attached drawings in which:

FIG. 1A and FIG. 1B illustrate a virtual memory address translated into a physical memory address according to a conventional TLB;

FIG. 2A and FIG. 2B illustrate a configuration of a conventional TLB;

FIG. 3 and FIG. 4 illustrate an exemplary assigning of a memory space to a process according to an exemplary embodiment of the present invention;

FIG. 5A and FIG. 5B illustrate an exemplary translation between a virtual memory address and a physical memory address according to an exemplary embodiment of the present invention.

FIG. 6A and FIG. 6B illustrate an exemplary configuration of a TLB according to an exemplary embodiment of the present invention.

FIG. 7 illustrates a flow diagram for the operation of the TLB according to an exemplary embodiment of the present invention.

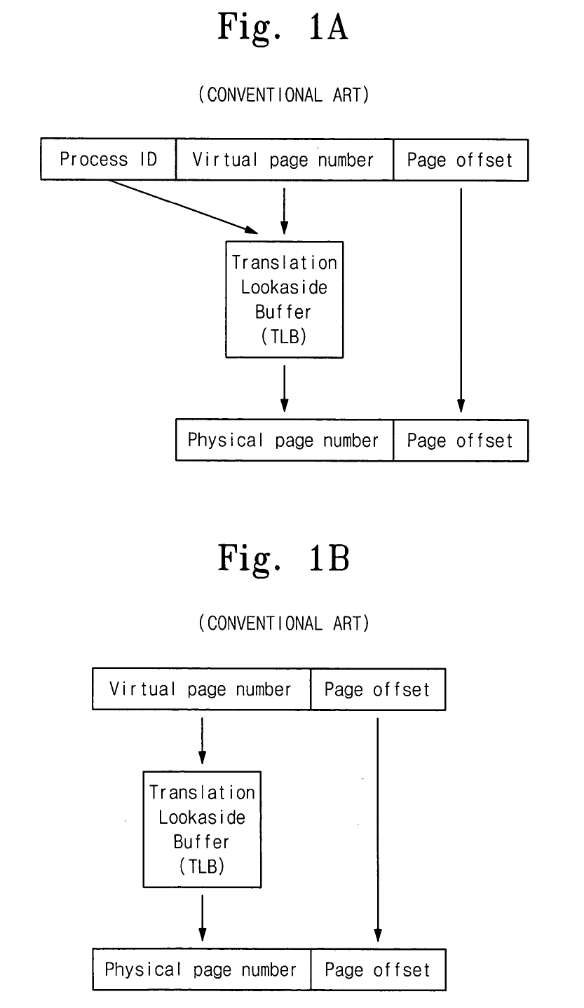

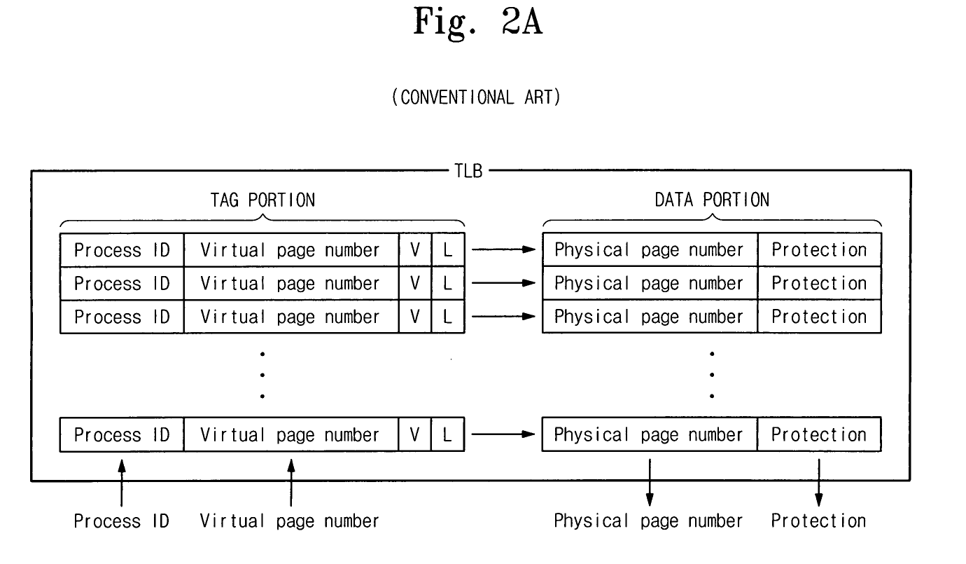

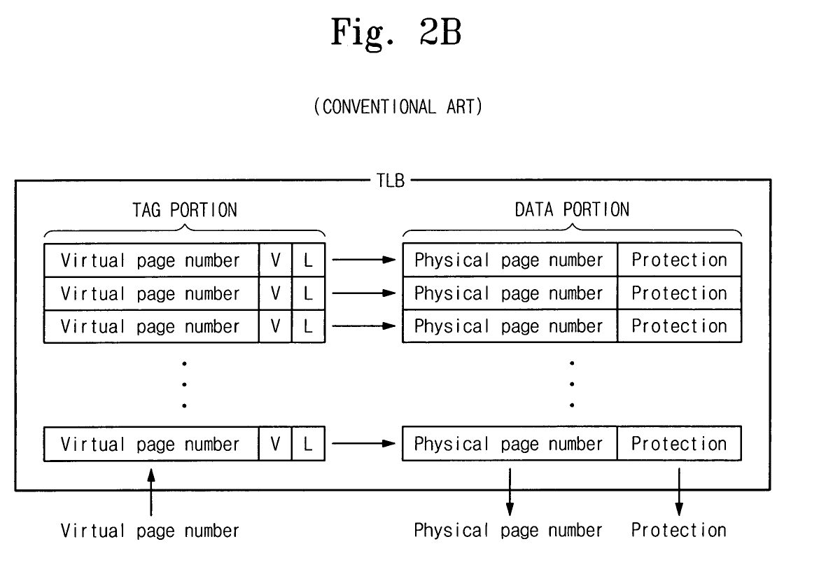

### DETAILED DESCRIPTION OF EXEMPLARY EMBODIMENTS OF THE INVENTION

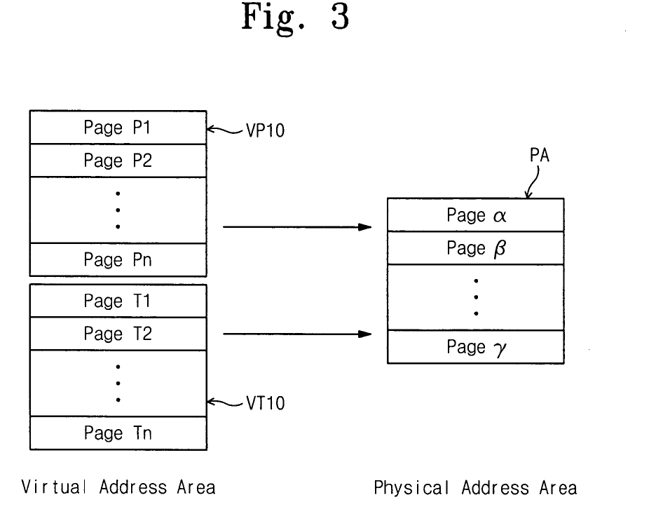

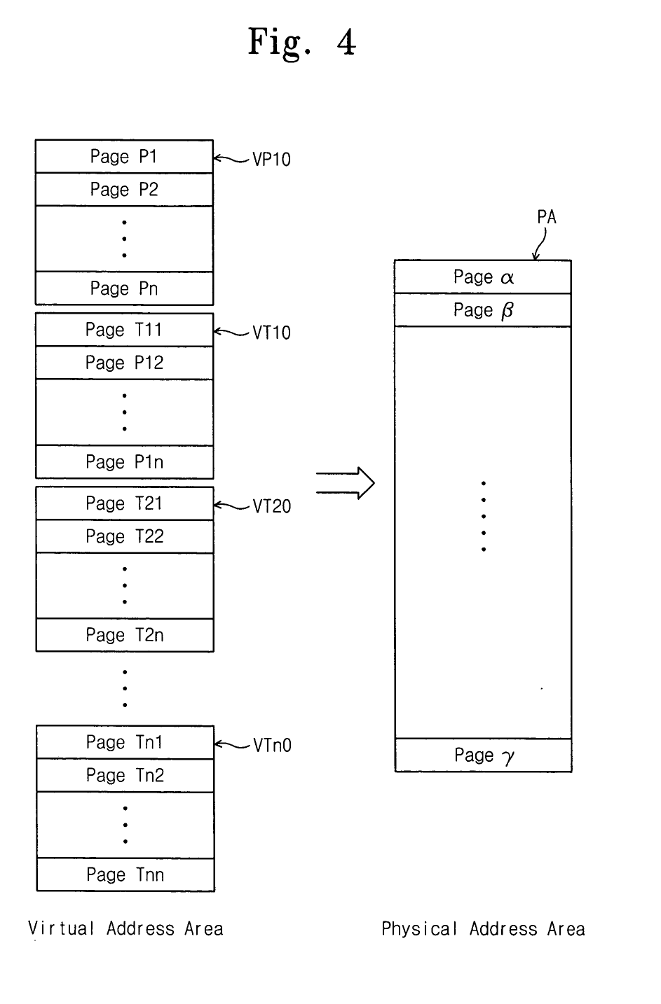

A method of assigning a memory space to one process will now be described with reference to FIG. 3 and FIG. 4 according to exemplary embodiments of the present invention. FIG. 3 includes a memory configuration where one thread belongs to one process (i.e., single-process single-thread) according to an exemplary embodiment of the present invention. FIG. 4 includes a memory configuration where a plurality of threads belong to one process (i.e., single-process multiple-thread) according to an exemplary embodiment of the present invention.

In an exemplary embodiment of the present invention, one process has a separate process memory space independent of a thread memory space. Referring to FIG. 3, one process memory space VP10 and one independent thread memory space VT10 may be assigned to a process having one thread.

Referring to FIG. 4, in an exemplary embodiment of the present invention, a process having n threads, one process memory space VP10 and n thread memory spaces, VT10-VTn0 for the respective n threads, may be assigned to a virtual memory space. The process memory space VP10 may be a memory space to access the n threads and may be used to transmit or receive various message/parameter/global data types of information. Further, n thread memory spaces VT10-VTn0 may be memory spaces in which each thread may be independently performed.

The n thread memory spaces VT10-VTn0 may have a memory space that is independent of the process memory space VP10 of a virtual memory space. These memory spaces may be independent and cannot access and/or read one another. In the case where threads communicate with each other, the process memory space VP10 may be used. Each of the threads inherits resources of the process of which it may be assigned to, and may use the resources freely.

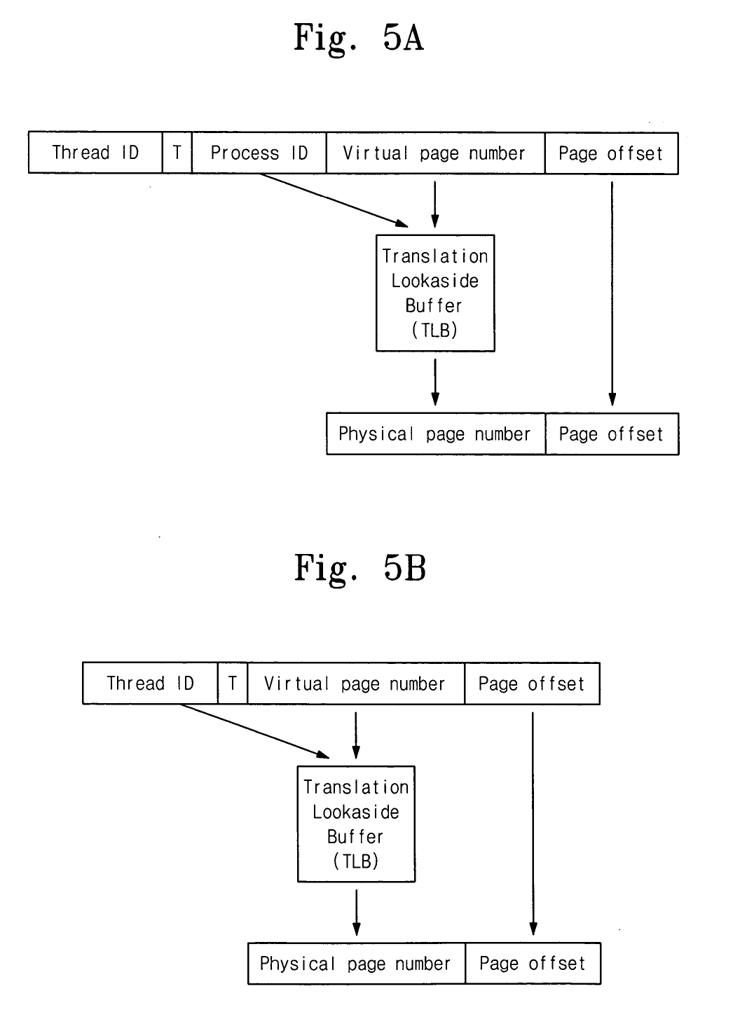

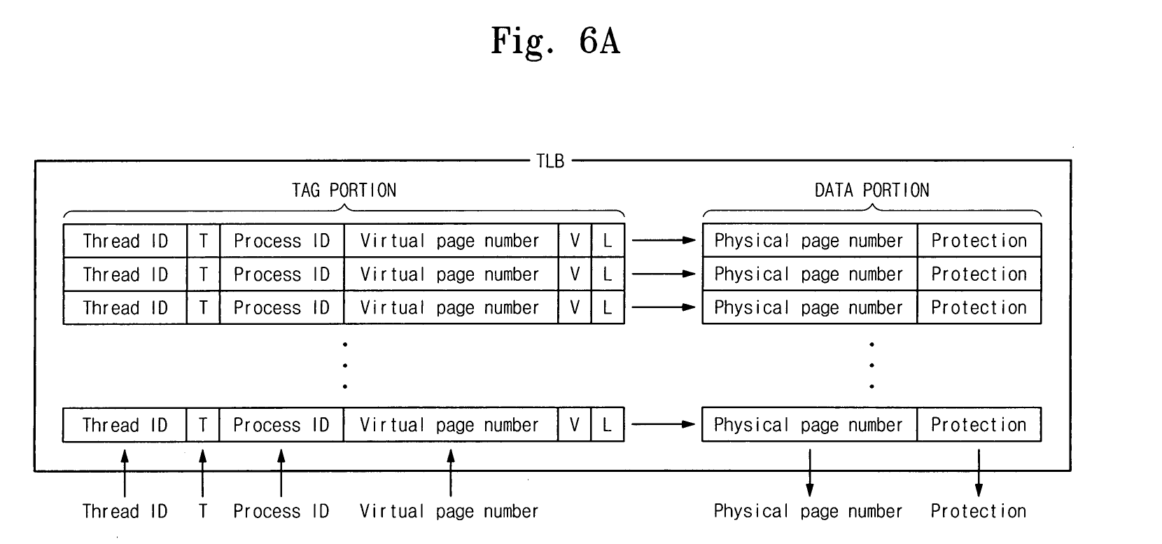

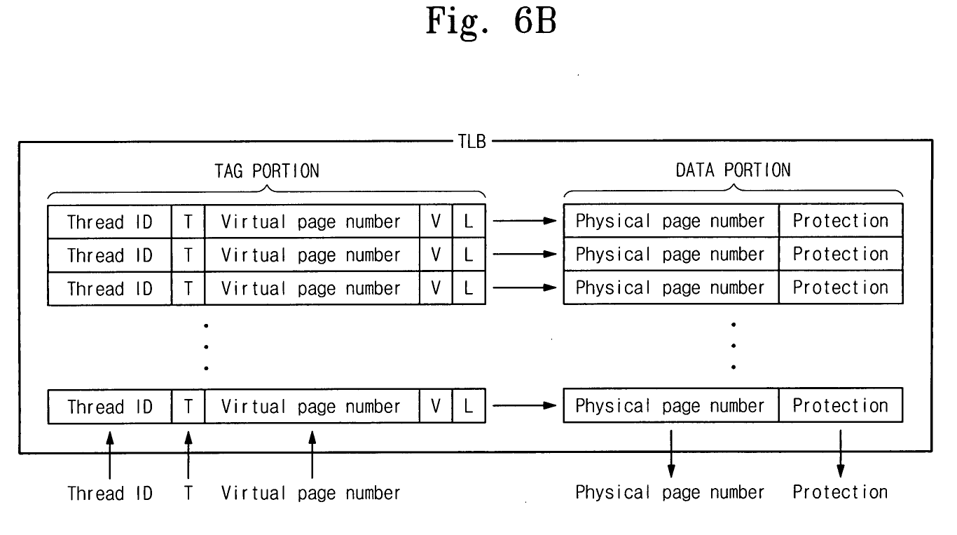

A method of translating a virtual memory address into a physical memory address according to an exemplary embodiment of the present invention will now be described with reference to FIG. 5A and FIG. 5B, and a TLB according to an exemplary embodiment of the present invention will also be described with reference to FIG. 6A and FIG. 6B.

In the examples shown in FIG. 5A and FIG. 6A, a process ID is used. In the examples shown in FIG. 5B and FIG. 6B, a process ID is omitted. Referring to FIG. 5A and FIG. 6A, a tag portion of a TLB may include a process ID, a thread ID, a thread bit (T), a virtual page number, and a page offset including a valid field (V), and a lock field (L), according to an exemplary embodiment of the present invention.

The data portion of the TLB may include a physical page number and an associated protection. The thread ID may represent an ID of a currently created thread. The number of bits used in the ID field may be used in determining the number of threads that one process may use. For example, if the thread ID is made up of three bits, one process can create up to 23 (eight) threads.

The Thread bit (T bit) discriminates whether a currently translated memory address is a memory address of a process memory space or a thread memory space. In the case where the T bit is zero (“0”), the process memory space may be used. In the case where the T bit is one (“1”), a thread memory space matching a current thread may be used. That is, in the case where the T bit is one (“1”), the thread ID may be compared and in the case where the T bit is zero (“0”), the thread ID may not be compared.

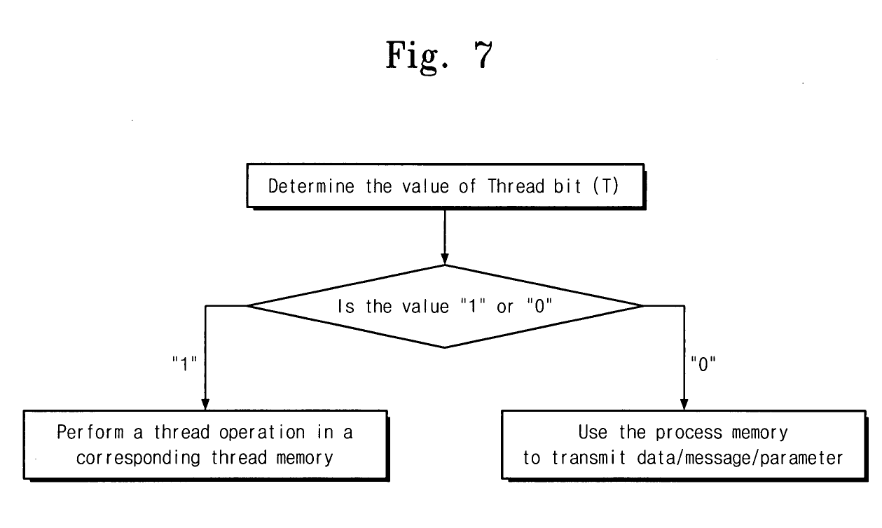

Referring to FIG. 7, in the case where the T bit is one (“1”), a thread operation may be executed in the thread memory space, thus creating a memory space that may be individual and independent of the other threads. Further, in the case where the T bit is zero (“0”), the thread uses the process memory space to transmit data, messages, parameters, and/or like kind information.

The thread ID, the thread bit, and/or the process ID, may be a part of the virtual memory address and may be individually realized as a separate register. For example, in a 64-bit device, a virtual memory address may be realized by a thread ID (3 bits), a thread bit (1 bit), a process ID (8 bits), a virtual memory page number (40 bits), and a page offset (12 bits). In a 32-bit device, a virtual memory address may be realized by a thread ID (3 bits), a thread bit (1 bit), and a process ID (8 bits), which may be realized as a separate register, and a virtual memory address may be realized as a virtual memory page number (20 bits) and a page offset (12 bits).

The thread bit may be set to zero (“0”) or one (“1”) through a special instruction or may be a part of the virtual memory address to be divided according to an address.

As explained previously, memory may be assigned to one process, and an independent memory space may be assigned to respective threads in the process and to a process memory space. The process memory space may be accessed by the respective threads, that may be assigned thereto. Therefore, it may be possible to prevent memory collision between threads and/or program protection problems. Further, it may be possible to reduce the effort required for managing a memory during programming.

While the present invention has been particularly shown and described with reference to exemplary embodiments thereof, it will be understood by those of ordinary skill in the art that various changes in form and details may be made herein without departing from the spirit and scope of the present invention as defined by the following claims.

1. A microprocessor for simultaneously processing a plurality of processes, comprising:
at least one process memory assigned to a plurality of processes; and
a plurality of thread memories assigned to a plurality of threads in the corresponding plurality of processes, where the plurality of thread memories are independent from the process memory.

2. The microprocessor of claim 1, wherein each of the plurality of thread memories are assigned to a corresponding thread.

3. The microprocessor of claim 1, wherein the process memory is used by the plurality of threads.

4. A method of assigning a virtual memory to a microprocessor for simultaneously processing a plurality of processes, comprising:
assigning process memory to a plurality of corresponding processes; and
assigning thread memories to threads in the corresponding plurality of processes, where the thread memories are independent from the process memory.

5. The method as recited in claim 4, wherein each of the thread memories are assigned to a corresponding thread.

6. The method as recited in claim 4, wherein the process memory is used by the threads.

7. A translation lookaside buffer of a microprocessor, comprising:
a tag unit that includes a thread ID and a virtual memory page number; and
a data unit including a physical memory page number, the data unit corresponding to the tag unit and used to translate a virtual memory address into a physical memory address.

8. The translation lookaside buffer of claim 7, wherein the tag unit includes a process ID.

9. The translation lookaside buffer of claim 7, wherein the tag unit includes a thread bit for determining whether the virtual memory address is an address for a process memory or a thread memory.

10. An apparatus comprising:
a process memory corresponding to a process, said process having at least one thread; and
a thread memory corresponding to the at least one thread, independent from the process memory, said process and said at least one thread have access to said process memory.

11. An apparatus comprising:
a virtual memory containing at least one process memory and at least two thread memories, where each of said at least two thread memories correspond to individual threads, and are independent from the at least one process memory.

12. The apparatus of claim 11, wherein the thread memories do not have access to other thread memories and only have access to the at least one process memory, and the thread memories may only be accessed by the at least one process memory.

13. The apparatus of claim 11, wherein the thread memories being accessed by the at least one process memory includes performing a read operation.

14. The apparatus of claim 11, wherein the at least one process memory is used by one of the at least two threads to access another one of said at least two threads.

15. The apparatus of claim 13, wherein the at least one process memory is the only memory that may be used by one of the at least two threads to access another one of said plurality of threads.

16. A method of assigning a virtual memory, comprising:
assigning at least one process to a process memory; and
assigning at least one thread in the process to a thread memory, where the thread memory is independent from the process memory.

17. A method of translating a virtual memory address into a physical memory address comprising:
determining the value of a thread bit; and
performing an operation in a thread memory or process memory depending on the determined thread bit value.

18. The method of claim 17, wherein the determined thread bit value causes the performed operation to be a thread operation, and the thread operation is performed in a corresponding thread memory.

19. The method of claim 17, wherein the determined thread bit value causes the operation performed to use the process memory to transmit at least one of data, a message, or a parameter.

20. A virtual memory apparatus including the translation lookaside buffer of claim 7.

21. A microprocessor including the virtual memory apparatus of claim 20.

22. A microprocessor for performing the method of claim 1.

23. A virtual memory apparatus for performing the method of claim 4.

24. A translation lookaside buffer for performing the method of claim 17.
